(19) United States
(12) Patent Application Publication
(10) Pub. No.: US 2022/0357920 A1
(43) Pub. Date: Nov. 10, 2022

(54) PROPORTIONAL CONTRIBUTION ANALYSIS FRAMEWORK

(71) Applicant: BUSINESS OBJECTS SOFTWARE LTD., Dublin (IE)

(72) Inventors: Paul O'HARA, Dublin (IE); Malte Christian KAUFMANN, Dublin (IE)

(21) Appl. No.: 17/313,359

(22) Filed: May 6, 2021

(51) Int. Cl. G06F 7/535

(52) U.S. Cl. CPC G06F 7/535

(57) ABSTRACT

Systems and methods include reception of data including a plurality of continuous features and a first discrete feature, each of the plurality of continuous features associated with a plurality of values and the first discrete feature associated with a plurality of discrete values, determination of an overall output value of a function based on the plurality of values associated with each of the plurality of continuous features, determination, for each discrete value of the plurality of discrete values, of an output value of the function based on ones of the plurality of values associated with the discrete value, scaling of the output value determined for each discrete value based on the determined output values and the overall output value, and presentation of the scaled output values.

### BACKGROUND

Today's organizations collect and store large volumes of data at an ever-increasing rate. Performing calculations upon or identifying patterns within this data can be time-consuming or even infeasible. Modern data analytics attempts to assist humans in efficiently understanding collected data. Such analytics may include application of machine learning techniques, specific data mining techniques, and purpose-designed mathematical functions.

Certain functions can be applied to an entire set of data or to subspaces of the data. For example, a function may be applied to data in order to determine a total profit for an organization. The function could also be applied to only a subspace of the data which is associated with a particular region, in order to determine a profit for the region. This function may be an example of a function which, when applied to an entire set of data, produces an output equal to the sum of the outputs produced when applied to subsets of the data which together comprise the entire set of data. Such a scenario provides a clear and intuitive understanding of the contribution of each subset to the total profit.

However, in the case of certain complex functions (e.g., non-linear), the sum of the outputs determined for each subset is not equal to the output determined for the entire set of data. It is therefore difficult to intuitively relate the proportional contribution of the subset-determined outputs to the output determined for the entire set of data. Determination of the relationship of each subset to the output determined for the entire set of data therefore requires detailed knowledge of the applied function, and may in turn may require derivation of additional functions to map the relationship between the function output when applied to subsets and the function output when applied to the entire set of data. Even if this approach were practical for a given function, it would be specific to the given function and unable to be generalized.

Systems are desired to provide a generic solution capable of efficiently mapping the relationship between the application of a function to subsets associated with respective discrete values of data and the application of the function to the entire set of data, without requiring any specialized knowledge of the underlying function.

### BRIEF DESCRIPTION OF THE DRAWINGS

FIG. 1 is a block diagram of an architecture to determine proportional contributions of each of a plurality of discrete values to an output value according to some embodiments.

FIG. 2 comprises a flow diagram of a process to determine proportional contributions of each of a plurality of discrete values to an output value according to some embodiments.

FIG. 3 comprises tabular representations of selected discrete feature data and continuous feature data according to some embodiments.

FIG. 4 illustrates aggregation of continuous feature data and application of a function to the aggregated data according to some embodiments.

FIG. 5 illustrates aggregation of continuous feature data for each of respective discrete values and application of a function to each aggregated data according to some embodiments.

FIG. 6 comprises a flow diagram of a process to determine proportional contributions of each of a plurality of discrete values to an output value according to some embodiments.

FIG. 7 is a tabular representation of a symmetric matrix of discrete value-specific output values according to some embodiments.

FIG. 8 is a vector including an overall output value according to some embodiments.

FIG. 9 is a tabular representation of weights associated with each discrete value of a discrete feature according to some embodiments.

FIG. 10 is a tabular representation of proportional contributions of each of a plurality of discrete values to an output value according to some embodiments.

FIG. 11 is an outward view of a user interface presenting proportional contributions of each of a plurality of discrete values to an output value according to some embodiments.

FIG. 12 illustrates a system to provide data analytics according to some embodiments.

FIG. 13 is a block diagram of a hardware system for determining proportional contributions of each of a plurality of discrete values to an output value according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

Some embodiments provide an interpretable mapping between the output of any calculation as applied to respective discrete values of a discrete feature within a set of data and the output of the calculation as applied to the entire set of data. Some embodiments may determine such a mapping for each of multiple discrete features in parallel, and may therefore be particularly suited for cloud-based implementations.

As used herein, a feature refers to an attribute of a set of data. In the case of a tabular data, each column may be considered as representing a respective feature of the data, while each row is an instance of values of each feature of the data. A continuous feature is represented using numeric data having an infinite number of possible values within a selected range. A discrete feature is represented by data having a finite number of possible values, hereinafter referred to as discrete values. Temperature is an example of a continuous feature, while days of the week and gender are examples of a discrete feature.

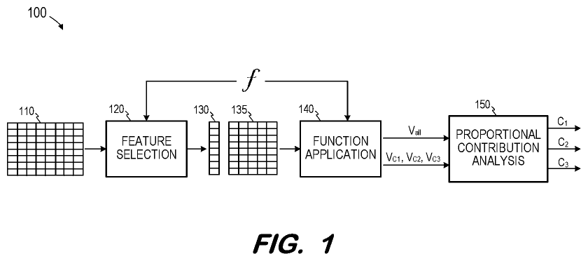

FIG. 1 is a block diagram of an architecture to determine proportional contributions of each of a plurality of discrete values to an output value according to some embodiments. The illustrated components may be implemented using any suitable combination of computing hardware and/or software that is or becomes known. In some embodiments, two or more components are implemented by a single computing device. Two or more components of FIG. 1 may be co-located. One or more components may be implemented as a cloud service (e.g., Software-as-a-Service, Platform-as-a-Service). A cloud-based implementation of any components of FIG. 1 may apportion computing resources elastically according to demand, need, price, and/or any other metric.

Data 110 may comprise values of database table. More specifically, data 110 may comprise rows of database table, with each row including a value of a corresponding database column, or feature. Data 110 consists of at least one discrete feature and one or more continuous features.

Feature selection component 120 identifies the continuous features which are utilized during evaluation of function ƒ and one or more discrete features for which discrete value-specific proportional contributions are to be determined. In the FIG. 1 example, column 130 of data 110 includes values of a discrete feature selected by feature selection component 120 and columns 135 includes values of continuous features selected by feature selection component 120 and used to evaluate function ƒ. Embodiments are not limited to selection of one discrete feature.

Function application component 140 applies function ƒ to selected continuous features 135. In particular, function application component 140 evaluates function ƒ using all rows of selected continuous features 135 to generate overall output value Vₐₗₗ. Function application component 140 also evaluates function ƒ for each discrete value of discrete feature 130 using the rows of selected continuous features 135 which are associated with the discrete value. For example, function application component 140 generates output value V_{C1} based on rows of selected continuous features 135 which correspond to a first discrete value (i.e., discrete value C1) of discrete feature 130, generates output value V_{C2} based on rows of selected continuous features 135 which correspond to a second discrete value (i.e., discrete value C2) of discrete feature 130, and continues in this manner for each discrete value of discrete feature 130.

Proportional contribution analysis component 150 determines the proportional contribution which each discrete value makes to the overall output value. Generally, and as will be described in more detail below, a single scaling value is determined which is applied to each discrete value-specific output value such that the sum of the thusly-scaled discrete value-specific output values equals the overall output value. Accordingly, system 100 may provide an interpretable explanation of how the output value determined for each discrete value contributes to the output value of the function when applied to the entire set of data.

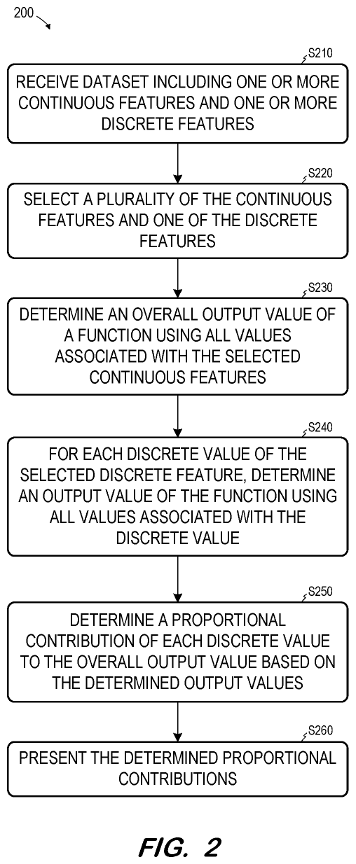

FIG. 2 is a flow diagram of process 200 to determine proportional contributions of each of a plurality of discrete values to an output value according to some embodiments. Process 200 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any one or more processing units, including but not limited to a processor, a processor core, and a processor thread. Embodiments are not limited to the examples described below.

Process 200 may be initiated by a request for proportional contributions of each of a plurality of discrete values to an output value of a function. Such a request may be received from an end-user via data analytics application. In one non-exhaustive example, an end-user operates an inventory management application to request calculation of an output value of a function based on an input procurement table.

The input data is received at S210, in a structured form such as a tabular format. The structured format facilitates definition of one or more continuous features and one or more discrete features with the data. At least one of the discrete features is not used to calculate the desired function.

A plurality of the continuous features and one of the discrete features is selected at S220. The plurality of continuous features are those features which are needed to evaluate the function which outputs the requested value. In other words, the selected continuous features represent the variables of the function.

For clarity of the following explanation, it will be assumed that only one discrete feature is selected at S220. Embodiments are not limited to the selection of one discrete feature. Accordingly, the foregoing description will note variations to the described process which would be occur in the case of more than one selected discrete feature. In some embodiments, if no discrete features are specified by a user at S220, then all discrete features of the data are assumed to be selected.

FIG. 3 illustrates column 310 of a selected discrete feature and columns 320 of two selected continuous features according to one example. Each column includes values associated with its respective feature. Columns 310 and 320 may comprise columns of a set of data which was received at S210 and which includes one or more other columns of discrete or continuous features. The continuous features of columns 320 are used in the calculation of the function of the present example, and the discrete feature of column 310 is not used in the calculation.

Next, at S230, an overall output value of the function is determined using all the values associated with the selected continuous features. In some embodiments, the values of each continuous feature are aggregated to result in one value per continuous feature. The function is then applied to the set of aggregated values.

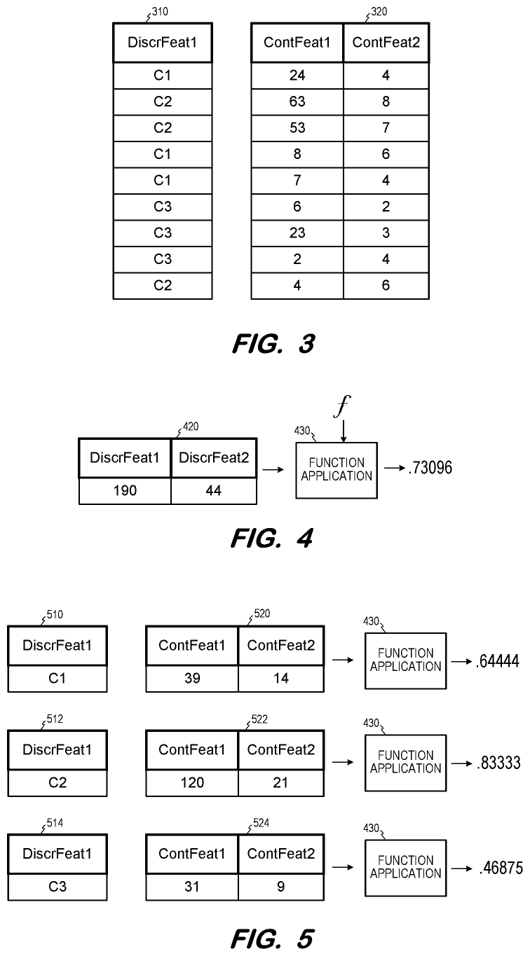

FIG. 4 illustrates aggregation at S230 according to some embodiments. All values of each of columns 320 are summed to create a single aggregated value 420 associated with each column. Any other aggregation (e.g., average, min, max) may be used. FIG. 4 further illustrates function application component 430 for applying the subject function ƒ to aggregated values 420. In the present example, the overall output value determined at S230 is 0.73096.

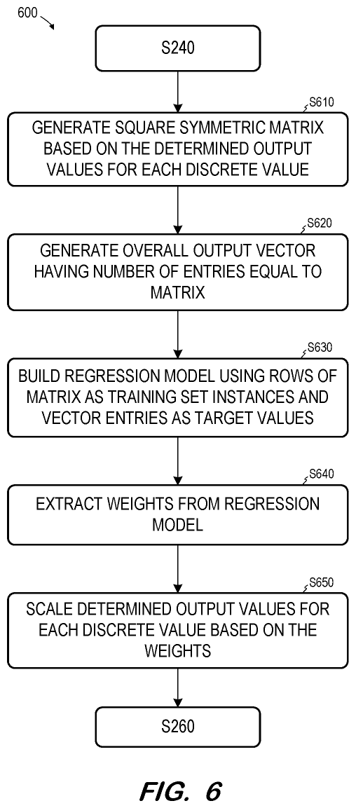

At S240, an output value of the function is determined for each discrete value of the selected discrete feature. Determination of the output value for a particular discrete value is based on the values of the selected continuous features which are associated with that discrete value. As described with respect to S230, the values of the selected continuous features which are associated with each discrete value may be initially identified and aggregated. Each of the three discrete values (i.e., C1, C2, C3) of column 310 is associated with a respective three rows of continuous feature columns 320. FIG. 5 shows aggregations, for each discrete value, of the associated three rows of continuous feature columns 320. FIG. 5 also shows output values determined by function application component 430 for each discrete value based on the aggregated values associated with the discrete value.

If more than one discrete feature is selected at S220, the process illustrated at FIG. 5 is repeated for each discrete value. That is, a separate output value of the function is determined for each discrete value of each selected discrete feature.

The proportional contribution of each discrete value to the overall output value is determined at S250 based on the output values determined at S230 and S240. As mentioned above, and according to some embodiments, each discrete value-specific output value is scaled such that the sum of the thusly-scaled discrete value-specific output values equals the overall output value determined at S230.

Process 600 of FIG. 6 is an implementation of S250 according to some embodiments. Implementations of S250 are not limited to process 600.

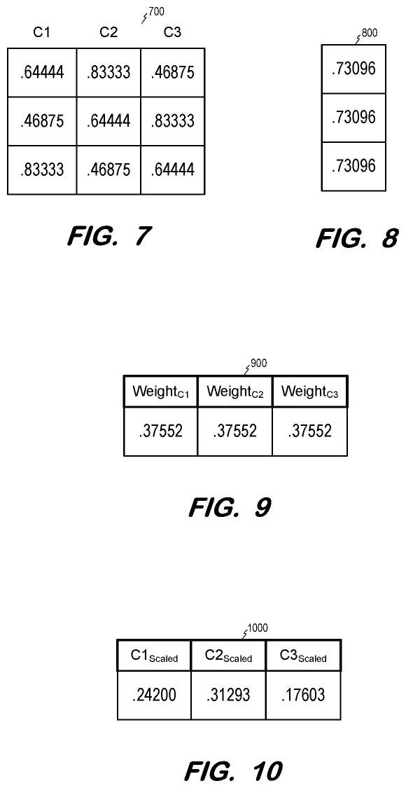

At S610, a square symmetric matrix is generated based on the output values determined for each discrete value at S240. FIG. 7 illustrates matrix 700 according to some embodiments. The number of rows and columns of matrix 700 equals the number of discrete values of the selected discrete feature.

Each row and each column of matrix 700 includes all of the output values of FIG. 5, each row includes the output values in a different order than each other row, and each column includes the output values in a different order than each other column. The first row of matrix 700 associates each output value with its associated discrete value (i.e., C1, C2, C3), and the values of each other row are right-shifted with respect to the immediately preceding row. If more than one discrete feature has been selected, such a square matrix is determined for each discrete feature based on the output values associated with the feature's discrete values.

An overall output vector is generated at S620. The number of entries of the overall output vector is equal to the number of rows of the symmetric matrix (i.e., the number of discrete values of the associated discrete feature). Moreover, as shown in FIG. 8, each entry of vector 800 is populated with the overall output value determined at S230.

At S630, and for each selected discrete feature, the associated symmetric square matrix and overall output vector are used to build a regression model to predict the overall output value as applied to the entire input data. In particular, the rows of the symmetric square matrix are used as training set instances, with each column representing independent input features, and the overall output vector is used as the dependent feature, with each entry representing the target value to be predicted for a corresponding row of the symmetric square matrix. The linear regression algorithm may comprise a least squares algorithm or any other suitable regression algorithm from which weights can be extracted.

The learned weights for each discrete value are extracted from the regression model at S640. FIG. 9 illustrates weights 900 extracted for each of discrete values C1, C2 and C3 of the discrete feature. As shown, each of weights 900 is identical. According to some implementations, each of weights 900 equals the overall output value divided by the sum of the output values determined for the plurality of discrete values.

The output values determined at S240 are scaled at S650 based on the extracted weights. In the present example, each output value of a discrete value is multiplied with the weight associated with the discrete value. FIG. 10 illustrates scaled output values 1000 associated with each discrete value C1, C2 and C3. Notably, the sum of values 1000 is equal to the overall output value determined at S230. Accordingly, scaled values 1000 provide an interpretable indication of the proportional contribution of each discrete value to the overall output value determined based on the entire set of data.

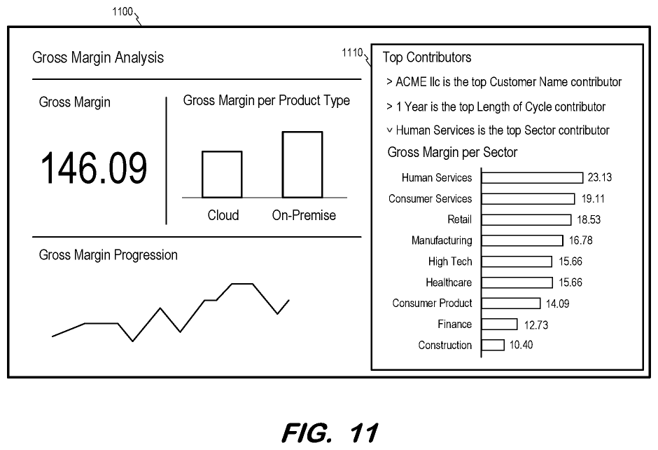

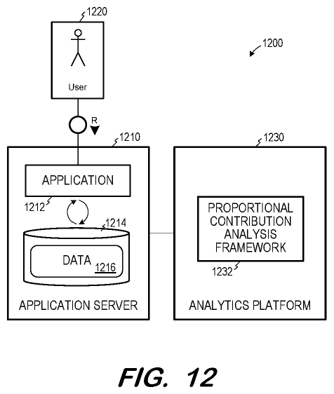

Returning to process 200, the proportional contributions are presented at S260. FIG. 11 illustrates user interface 1100 of data analysis application providing proportional contribution determinations according to some embodiments. A user may execute a Web browser to access the application via HyperText Transfer Protocol and receive user interface 1100 in return.

User interface 1100 shows, for example, a gross margin value is calculated based on data according to an associated function. As described above, the function takes into account several features of the data to generate the gross margin.

Panel 1110 is invoked to provide additional information regarding the calculated gross margin value. In particular, panel 1110 indicates, for each of three features of the data, a value which contributes most to the calculated value with respect to other values of the feature. With respect to the discrete feature Sector, panel 1110 presents the proportional contributions of each discrete value of the feature to the calculated overall gross margin value. The proportional contributions may have been determined as described herein. Advantageously, and regardless of the computational complexity of the function used to calculate the gross margin value, the sum of the presented proportional contributions equals the calculated overall gross margin value.

FIG. 12 illustrates a system to provide data analytics to applications according to some embodiments. Application server 1210 may comprise an on-premise or cloud-implemented server providing an execution platform and services to applications such as application 1212. Application 1212 may comprise program code executable by a processing unit to provide functions to users such as user 1220 based on logic and on data 1216 stored in data store 1214. Data 1216 may be column-based, row-based, object data or any other type of data that is or becomes known. Data store 1214 may comprise any suitable storage system such as database system, which may be partially or fully remote from application server 1210, and may be distributed as is known in the art.

According to some embodiments, user 1220 may interact with application 1212 (e.g., via a Web browser executing a front-end UI application associated with application 1212) to request calculation of a value based on data of data 1216. Next, user 1220 may request analysis of the calculated value. To perform this analysis, application 1212 may access analytics platform 1230. Analytics platform 1230 may also be implemented by on-premise or cloud-based servers.

Analytics platform 1230 includes program code of proportional contribution analysis framework 1232, which may be executed to determine discrete value-specific proportional contributions to an overall value as described herein. These determined proportional contributions may be provided to application 1212 for presentation to user 1220. According to some embodiments, application 1212 is capable of determining discrete value-specific proportional contributions as described herein. Analytics platform 1230 may provide additional functionality to applications, such as but not limited to machine learning model training and inference.

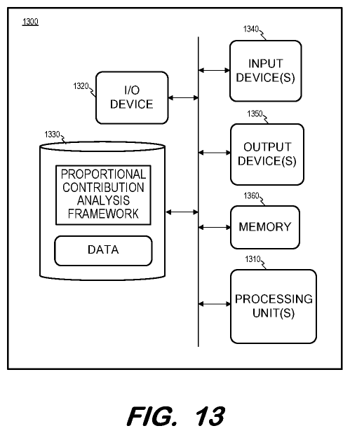

FIG. 13 is a block diagram of a hardware system for determining proportional contributions according to some embodiments. Hardware system 1300 may comprise a general-purpose computing apparatus and may execute program code to perform any of the functions described herein. Hardware system 1300 may be implemented by a distributed cloud-based server and may comprise an implementation of analytics platform 1230 in some embodiments. Hardware system 1300 may include other unshown elements according to some embodiments.

Hardware system 1300 includes processing unit(s) 1310 operatively coupled to I/O device 1320, data storage device 1330, one or more input devices 1340, one or more output devices 1350 and memory 1360. I/O device 1320 may facilitate data exchange with external devices, such as an external network, the cloud, or data storage device. Input device(s) 1340 may comprise, for example, a keyboard, a keypad, a mouse or other pointing device, a microphone, knob or a switch, an infra-red (IR) port, a docking station, and/or a touch screen. Input device(s) 1340 may be used, for example, to enter information into hardware system 1300. Output device(s) 1350 may comprise, for example, a display (e.g., a display screen) a speaker, and/or a printer.

Data storage device 1330 may comprise any appropriate persistent storage device, including combinations of magnetic storage devices (e.g., magnetic tape, hard disk drives and flash memory), optical storage devices, Read Only Memory (ROM) devices, and RAM devices, while memory 1360 may comprise a RAM device.

Data storage device 1330 stores program code executed by processing unit(s) 1310 to cause hardware system 1300 to implement any of the components and execute any one or more of the processes described herein. Embodiments are not limited to execution of these processes by a single computing device. Data storage device 1330 may also store data and other program code for providing additional functionality and/or which are necessary for operation of hardware system 1300, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processing unit to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing processor-executable program code; and
a processing unit to execute the processor-executable program code to cause the system to:
receive data including a plurality of continuous features and a first discrete feature, each of the plurality of continuous features associated with a plurality of values and the first discrete feature associated with a plurality of discrete values;
determine an overall output value of a function based on the plurality of values associated with each of the plurality of continuous features;
determine, for each discrete value of the plurality of discrete values, an output value of the function based on ones of the plurality of values associated with the discrete value;
scale the output value determined for each discrete value based on the determined output values and the overall output value; and
present the scaled output values.

2. A system according to claim 1, wherein determination of the overall output value of the function comprises aggregation, for each of the plurality of continuous features, of the plurality of values associated with the continuous feature, and determination of the overall output value of the function based on the aggregated value associated with each continuous feature.

3. A system according to claim 2, wherein determination of the output value of the function for each discrete value comprises aggregation, for each discrete value, of the plurality of values associated with the discrete value, and determination of the output value of the function based on the aggregated values associated with the discrete value.

4. A system according to claim 1, wherein scaling of the output value determined for each discrete value comprises determination of a scaling value equal to the overall output value divided by a sum of the output values determined for the plurality of discrete values.

5. A system according to claim 1, wherein the data includes a second discrete feature associated with a second plurality of discrete values, the processing unit to execute the processor-executable program code to cause the system to:
determine, for each second discrete value of the second plurality of discrete values, a second output value of the function based on ones of the plurality of values associated with the second discrete value;
scale the second output value determined for each second discrete value based on the determined second output values and the overall output value; and
present the scaled second output values.

6. A method comprising:
receiving data including a plurality of continuous features and a first discrete feature, each of the plurality of continuous features associated with a plurality of values and the first discrete feature associated with a plurality of discrete values;
determining an overall output value of a function based on the plurality of values associated with each of the plurality of continuous features;
determining, for each discrete value of the plurality of discrete values, an output value of the function based on ones of the plurality of values associated with the discrete value;
scaling the output value determined for each discrete value based on the determined output values and the overall output value; and
presenting the scaled output values.

7. A method according to claim 6, wherein determining the overall output value of the function comprises aggregating, for each of the plurality of continuous features, of the plurality of values associated with the continuous feature, and determining the overall output value of the function based on the aggregated value associated with each continuous feature.

8. A method according to claim 7, wherein determining the output value of the function for each discrete value comprises aggregating, for each discrete value, the plurality of values associated with the discrete value, and determining the output value of the function based on the aggregated values associated with the discrete value.

9. A method according to claim 6, wherein scaling the output value determined for each discrete value comprises determining a scaling value equal to the overall output value divided by a sum of the output values determined for the plurality of discrete values.

10. A method according to claim 6, wherein the data includes a second discrete feature associated with a second plurality of discrete values, the method further comprising:
determining, for each second discrete value of the second plurality of discrete values, a second output value of the function based on ones of the plurality of values associated with the second discrete value;
scaling the second output value determined for each second discrete value based on the determined second output values and the overall output value; and
presenting the scaled second output values.

11. A non-transitory medium storing processor-executable program code executable by a processing unit of a computing system to cause the computing system to:
receive data including a plurality of continuous features and a first discrete feature, each of the plurality of continuous features associated with a plurality of values and the first discrete feature associated with a plurality of discrete values;
determine an overall output value of a function based on the plurality of values associated with each of the plurality of continuous features;
determine, for each discrete value of the plurality of discrete values, an output value of the function based on ones of the plurality of values associated with the discrete value;
scale the output value determined for each discrete value based on the determined output values and the overall output value; and
present the scaled output values.

12. A medium according to claim 11, wherein determination of the overall output value of the function comprises aggregation, for each of the plurality of continuous features, of the plurality of values associated with the continuous feature, and determination of the overall output value of the function based on the aggregated value associated with each continuous feature.

13. A medium according to claim 12, wherein determination of the output value of the function for each discrete value comprises aggregation, for each discrete value, of the plurality of values associated with the discrete value, and determination of the output value of the function based on the aggregated values associated with the discrete value.

14. A medium according to claim 11, wherein scaling of the output value determined for each discrete value comprises determination of a scaling value equal to the overall output value divided by a sum of the output values determined for the plurality of discrete values.

15. A medium according to claim 11, wherein the data includes a second discrete feature associated with a second plurality of discrete values, the processor-executable program code executable by a processing unit of a computing system to cause the computing system to:
determine, for each second discrete value of the second plurality of discrete values, a second output value of the function based on ones of the plurality of values associated with the second discrete value;
scale the second output value determined for each second discrete value based on the determined second output values and the overall output value; and
present the scaled second output values.
